(19) United States
(12) Patent Application Publication
(10) Pub. No.: US 2022/0324731 A1
(43) Pub. Date: Oct. 13, 2022

(54) SALTWATER TO FRESHWATER CONVERTER

(71) Applicants: Dag Arild VALAND, Wachtberg (DE); Ove T. Aanensen, Kristiansand (NO)

(72) Inventors: Dag Arild VALAND, Wachtberg (DE); Ove T. Aanensen, Kristiansand (NO)

(21) Appl. No.: 17/714,415

(22) Filed: Apr. 6, 2022

Related U.S. Application Data
(60) Provisional application No. 63/172,283, filed on Apr. 8, 2021.

(51) Int. Cl. C02F 1/461

(52) U.S. Cl. CPC C02F 1/46109; C02F 2103/08

(57) ABSTRACT

Saltwater to freshwater conversion cells are provided. The saltwater to freshwater conversion cell includes a positive electrode; a negative electrode disposed opposite and parallel to the positive electrode; a first plastic perforated plate positioned adjacent to the positive electrode and between the positive electrode and the negative electrode; a second plastic perforated plate positioned adjacent to the negative electrode and between the positive electrode and the negative electrode; a power supply configured to generate an electric field between the positive electrode and the negative electrode; and a saltwater stream comprising a plurality of positively charged sodium ions and a plurality of negatively charged chloride ions, the saltwater stream flowing through the conversion cell. The positive electrode and the first plastic perforated plate define a chloride-dense water channel, the negative electrode and the second plastic perforated plate define a sodium-dense water channel, and the first plastic perforated plate and the second plastic perforated plate define a desalinated water channel. The electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel.

### CROSS REFERENCE TO RELATED APPLICATIONS

This application claims priority to and benefit of U.S. Provisional Patent Application No. 63/172,283, filed Apr. 8, 2021, which is incorporated by reference herein in its entirety.

### FIELD

The presently-disclosed invention relates generally to saltwater to freshwater converters and, more particularly, saltwater to freshwater conversion cells and systems and methods for converting saltwater to freshwater.

### BACKGROUND

The need for freshwater is a global problem. Many countries have direct access to saltwater through oceans and seas, as well as brackish water in neighboring marshes. This saltwater, however, is not safe for human consumption. Various methods of converting saltwater to freshwater have been proposed and used for thousands of years, but many of these methods are not efficient and/or sanitary.

Accordingly, there still exists a need for devices, systems, and methods for cleanly and efficiently converting saltwater to freshwater.

### BRIEF SUMMARY

One or more embodiments of the invention may address one or more of the aforementioned problems. Certain embodiments according to the invention provide saltwater to freshwater conversion cells. The saltwater to freshwater conversion cell includes a positive electrode; a negative electrode disposed opposite and parallel to the positive electrode; a first plastic perforated plate positioned adjacent to the positive electrode and between the positive electrode and the negative electrode; a second plastic perforated plate positioned adjacent to the negative electrode and between the positive electrode and the negative electrode; a power supply configured to generate an electric field between the positive electrode and the negative electrode; and a saltwater stream comprising a plurality of positively charged sodium ions and a plurality of negatively charged chloride ions, the saltwater stream flowing through the conversion cell. The positive electrode and the first plastic perforated plate define a chloride-dense water channel, the negative electrode and the second plastic perforated plate define a sodium-dense water channel, and the first plastic perforated plate and the second plastic perforated plate define a desalinated water channel. The electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel.

According to certain embodiments, the saltwater to freshwater conversion cell may further comprise a housing having a saltwater entry port, a sodium-dense water channel exit port, a chloride-dense water channel exit port, and a desalinated water channel exit port, wherein the positive electrode, the negative electrode, the first plastic perforated plate, and the second plastic perforated plate may be disposed within the housing. In some embodiments, the saltwater stream may enter the housing via the saltwater entry port, the sodium-dense water channel may exit the housing via the sodium-dense water channel exit port, the chloride-dense water channel may exit the housing via the chloride-dense water channel exit port, and the desalinated water channel may exit the housing via the desalinated water channel exit port.

According to certain embodiments, the power supply may be disposed within the housing. In some embodiments, the power supply may be a direct current (DC) power supply. In other embodiments, the power supply may be an alternating current (AC) power supply.

According to certain embodiments, the positive electrode and the negative electrode may comprise stainless steel. In some embodiments, the positive electrode and the negative electrode may comprise surfaces having an electrical insulating plastic coating.

In another aspect, certain embodiments according to the invention provide saltwater to freshwater conversion systems. The saltwater to freshwater conversion system includes at least a first saltwater to freshwater conversion cell and a second saltwater to freshwater conversion cell. Each of the saltwater to freshwater conversion cells includes a positive electrode; a negative electrode disposed opposite and parallel to the positive electrode; a first plastic perforated plate positioned adjacent to the positive electrode and between the positive electrode and the negative electrode; a second plastic perforated plate positioned adjacent to the negative electrode and between the positive electrode and the negative electrode; a power supply configured to generate an electric field between the positive electrode and the negative electrode; and a saltwater stream comprising a plurality of positively charged sodium ions and a plurality of negatively charged chloride ions, the saltwater stream flowing through the conversion cell. The positive electrode and the first plastic perforated plate define a chloride-dense water channel, the negative electrode and the second plastic perforated plate define a sodium-dense water channel, and the first plastic perforated plate and the second plastic perforated plate define a desalinated water channel. The electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel.

According to certain embodiments, the system may comprise three saltwater to freshwater conversion cells. In other embodiments, the system may comprise four saltwater to freshwater conversion cells. In further embodiments, the system may comprise five saltwater to freshwater conversion cells.

According to certain embodiments, each saltwater to freshwater conversion cell may further comprise a housing having a saltwater entry port, a sodium-dense water channel exit port, a chloride-dense water channel exit port, and a desalinated water channel exit port, wherein the positive electrode, the negative electrode, the first plastic perforated plate, and the second plastic perforated plate may be disposed within the housing. In other embodiments, at least the first saltwater to freshwater conversion cell and the second saltwater to freshwater conversion cell may be disposed in a housing, the housing having a saltwater entry port, a sodium-dense water channel exit port, a chloride-dense water channel exit port, and a desalinated water channel exit port. In some embodiments, the sodium-dense water channel may exit the housing via the sodium-dense water channel exit port, the chloride-dense water channel may exit the housing via the chloride-dense water channel exit port, and the desalinated water channel may exit the housing via the desalinated water channel exit port. In further embodiments, the sodium-dense water channel exit port and the chloride-dense water channel exit port of each of the saltwater to freshwater conversion cells may drain into a wastewater collection unit, the desalinated water channel exit port of the first saltwater to freshwater conversion cell may drain into the saltwater entry port of the second saltwater to freshwater conversion cell, and the desalinated water channel exit port of the second saltwater to freshwater conversion cell may drain either into a freshwater collection unit or a saltwater entry port of a third saltwater to freshwater conversion cell.

According to certain embodiments, the power supply may be a direct current (DC) power supply.

In yet another aspect, certain embodiments according to the invention provide methods for converting saltwater to freshwater. The method includes providing a saltwater stream comprising a plurality of positively charged sodium ions and a plurality of negatively charged chloride ions; flowing the saltwater stream through a saltwater to freshwater conversion cell, the saltwater to freshwater conversion cell comprising a positive electrode, a negative electrode, a first plastic perforated plate, and a second plastic perforated plate, wherein the positive electrode and the first plastic perforated plate define a chloride-dense water channel, the negative electrode and the second plastic perforated plate define a sodium-dense water channel, and the first plastic perforated plate and the second plastic perforated plate define a desalinated water channel; generating an electric field across the saltwater stream; collecting wastewater from the sodium-dense water channel and the chloride-dense water channel; and collecting freshwater from the desalinated water channel. The electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel such that the plurality of positively charged sodium ions and the plurality of negatively charged chloride ions are substantially removed from water flowing through the desalinated water channel.

According to certain embodiments, the method may further comprise disposing the wastewater or recycling the wastewater through the saltwater to freshwater conversion cell. In further embodiments, the method may further comprise flowing the freshwater through one or more additional saltwater to freshwater conversion cells.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective interior view of a saltwater to freshwater converter cell in accordance with certain embodiments of the invention;

FIG. 2 is a top perspective interior view of a saltwater to freshwater converter cell in accordance with certain embodiments of the invention;

FIG. 3 is a perspective exterior view of the front of a saltwater to freshwater converter in accordance with certain embodiments of the invention;

FIG. 4 is a perspective exterior view of the back of a saltwater to freshwater converter in accordance with certain embodiments of the invention;

FIG. 5 is a schematic view of a one cell saltwater to freshwater converter in accordance with certain embodiments of the invention;

FIG. 6 illustrates the effect of various electric field strengths on ion density in a saltwater to freshwater converter in accordance with certain embodiments of the invention;

FIG. 7 is a schematic view of a saltwater to freshwater conversion system in accordance with certain embodiments of the invention;

FIG. 8 illustrates the effect of the number of saltwater to freshwater conversion cells in a saltwater to freshwater conversion system on ion density in accordance with certain embodiments of the invention; and

FIG. 9 is a block diagram of a method for converting saltwater to freshwater in accordance with certain embodiments of the invention.

### DETAILED DESCRIPTION

The invention now will be described more fully hereinafter with reference to the accompanying drawings, in which some, but not all embodiments of the inventions are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise.

The invention includes, according to certain embodiments, converters and/or conversion cells, systems, and methods for converting saltwater to freshwater. The converters, systems, and methods are all based on a conversion cell that includes positive and negative electrodes, perforated plates positioned adjacent to the electrodes, and a power supply.

Saltwater is freshwater (H₂O) with salt (NaCl) crystals dissolved therein. The NaCl crystals are cubical and electrically neutral, which means that the number of Na⁺ ions and the number of Cl⁻ ions in the water are substantially equal.

The force (F) on the ions in the water running through the conversion cell is influenced by the electrical field strength E=U/d in the water between the electrodes with the electrical potential difference (U) and the distance (d). Force (F) is calculated according to Formula 1:

F=Z*e*E (1)

where Z is the number of elementary charges of the ion, and e is the elementary charge of an electron (1.60217653*10⁻¹⁹ coulombs). This force gives the Na⁺ ions a velocity according to Formula 2:

v(Na)=u(Na)*E (2)

and gives the Cl⁻ ions a velocity according to Formula 3:

v(Cl)=u(Cl)*E (3)

where the mobility of the Na⁺ ions u(Na)=6.75*10⁻⁸*m²*V⁻¹*s⁻¹, and the mobility of the Cl⁻ ions u(Cl)=6.85*10⁻⁸*m²*V⁻¹*s⁻¹. The ions experience limited mobility due to the friction they encounter by moving in the water. As such, the velocity of the ions will not be higher than when the friction force is equal to the electric field force (E).

As a result of these forces, including the electric field force (E) in the water flowing between to the two electrodes connected to the power supply (e.g., DC power supply), Na⁺ ions may be collected in one volume of water, and Cl⁻ ions may be collected in another volume of water. In particular, the Cl⁻ ionic density is higher in the water volume near the positive electrode, and the Na⁺ ionic density is higher in the water volume near the negative electrode. When these two water volumes are drained out of the conversion cell, the water left in the middle of the conversion cell between the two electrodes has a lower density of dissolved NaCl than water entering the conversion cell. As discussed in more detail below, this water from the middle volume may be treated multiple (e.g., 3-4) times more to further decrease the NaCl density in the water (e.g., to about 6.25-12.5% of the original saltwater).

In this regard, the devices, systems, and methods disclosed herein are able to cleanly and efficiently convert saltwater to freshwater.

I. Saltwater to Freshwater Conversion Cells

Certain embodiments according to the invention provide saltwater to freshwater conversion cells. The saltwater to freshwater conversion cell includes a positive electrode; a negative electrode disposed opposite and parallel to the positive electrode; a first plastic perforated plate positioned adjacent to the positive electrode and between the positive electrode and the negative electrode; a second plastic perforated plate positioned adjacent to the negative electrode and between the positive electrode and the negative electrode; a power supply configured to generate an electric field between the positive electrode and the negative electrode; and a saltwater stream comprising a plurality of positively charged sodium ions and a plurality of negatively charged chloride ions, the saltwater stream flowing through the conversion cell. The positive electrode and the first plastic perforated plate define a chloride-dense water channel, the negative electrode and the second plastic perforated plate define a sodium-dense water channel, and the first plastic perforated plate and the second plastic perforated plate define a desalinated water channel. The electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel.

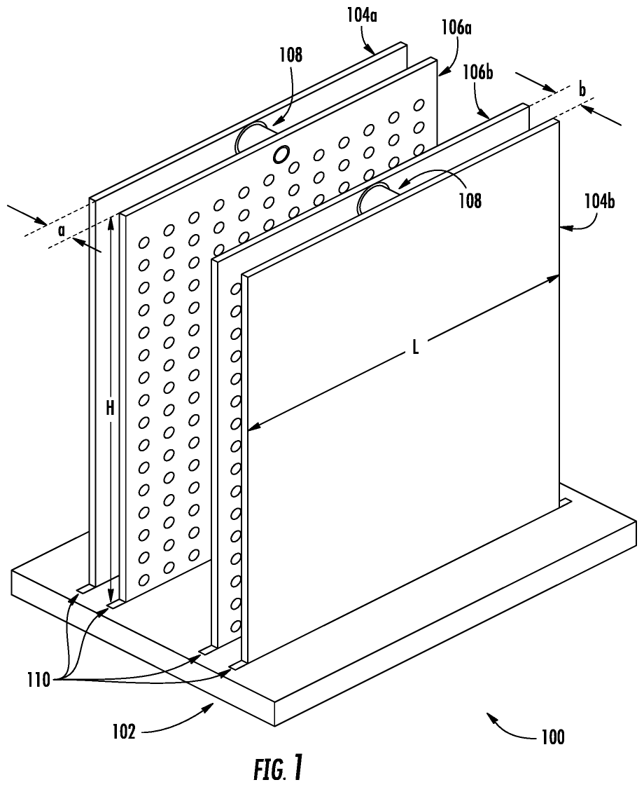

Turning now to FIG. 1, a saltwater to freshwater converter cell 100 is illustrated in accordance with certain embodiments of the invention. As shown in FIG. 1, the saltwater to freshwater converter cell 100 includes a positive electrode 104a disposed on a baseplate 102, a negative electrode 104b disposed opposite and parallel to the positive electrode 104a on the baseplate 102, a first plastic perforated plate 106a disposed adjacent to the positive electrode 104a and between the positive electrode 104a and the negative electrode 104b on the baseplate 102, and a second plastic perforated plate 106b disposed adjacent to the negative electrode 104b and between the positive electrode 104a and the negative electrode 104b on the baseplate 102. Each of the positive electrode 104a, negative electrode 104b, first plastic perforated plate 106a, and second plastic perforated plate 106b may be secured to the baseplate 102 via grooves 110.

According to certain embodiments, the positive electrode 104a and/or the negative electrode 104b may comprise stainless steel or any other suitable material for the electrodes that also conveys rust resistance as understood by a person of ordinary skill in the art. In such embodiments, the current flowing from a DC power supply may charge the electrodes to neutralize the approaching ions. In other embodiments, the positive electrode 104a and/or the negative electrode 104b may be painted with an electrical isolating plastic lacquer. In such embodiments, the power supply may only influence the conversion cell via the electric field strength.

In accordance with certain embodiments, and as with the first plastic perforated plate 106a and the second plastic perforated plate 106b, the baseplate 102 may also comprise plastic. In addition or in the alternative, the baseplate 102 may comprise any suitable nonconductive material as understood by a person of ordinary skill in the art.

In some embodiments, the positive electrode 104a and the negative electrode 104b may have the same thickness or different thicknesses. For example, in certain embodiments, the positive electrode 104a and/or the negative electrode 104b may comprise a thickness from about 0.1 mm to about 10 mm. In other embodiments, the positive electrode 104a and/or the negative electrode 104b may comprise a thickness from about 1 mm to about 5 mm. In further embodiments, the positive electrode 104a and/or the negative electrode 104b may comprise a thickness of about 2 mm. In this regard, the positive electrode 104a and/or the negative electrode 104b may comprise a thickness from at least about any of the following: 0.1, 0.5, 1, 1.5, 2, 2.5, 3, 3.5, 4, 4.5, 5, 5.5, 6, 6.5, 7, 7.5, 8, 8.5, 9, and 9.5 mm and/or at most about 10, 9.5, 9, 8.5, 8, 7.5, 7, 6.5, 6, 5.5, 5, 4.5, 4, 3.5, 3, 2.5, 2, 1.5, 1, and 0.5 mm (e.g., about 1-7 mm, about 0.5-5 mm, etc.).

Similarly, according to certain embodiments, the first plastic perforated plate 106a and the second plastic perforated plate 106b may have the same thickness or different thicknesses. For example, in certain embodiments, the first plastic perforated plate 106a and/or the second plastic perforated plate 106b may comprise a thickness from about 0.1 mm to about 10 mm. In other embodiments, the first plastic perforated plate 106a and/or the second plastic perforated plate 106b may comprise a thickness from about 1 mm to about 5 mm. In further embodiments, the first plastic perforated plate 106a and/or the second plastic perforated plate 106b may comprise a thickness of about 2 mm. In this regard, the first plastic perforated plate 106a and/or the second plastic perforated plate 106b may comprise a thickness from at least about any of the following: 0.1, 0.5, 1, 1.5, 2, 2.5, 3, 3.5, 4, 4.5, 5, 5.5, 6, 6.5, 7, 7.5, 8, 8.5, 9, and 9.5 mm and/or at most about 10, 9.5, 9, 8.5, 8, 7.5, 7, 6.5, 6, 5.5, 5, 4.5, 4, 3.5, 3, 2.5, 2, 1.5, 1, and 0.5 mm (e.g., about 1-7 mm, about 0.5-5 mm, etc.).

As can be seen in FIG. 1, the positive electrode 104a and the first plastic perforated plate 106a are separated by a non-zero distance a, and the negative electrode 104b and the second plastic perforated plate 106b are separated by a non-zero distance b. In some embodiments, for example, distance a may be equal to distance b. In other embodiments, for instance, distance a may be different from distance b. For example, in some embodiments, distance a and/or distance b may be from about 1 mm to about 10 mm. In other embodiments, distance a and/or distance b may be from about 2 mm to about 5 mm. In further embodiments, distance a and/or distance b may be about 4 mm. In this regard, distance a and/or distance b may be at least about any of the following: 1, 2, 3, 4, 5, 6, 7, 8, and 9 mm and/or at most about 10, 9, 8, 7, 6, 5, 4, 3, and 2 mm (e.g., about 1-7 mm, about 3-5 mm, etc.).

In certain embodiments, for example, as shown in FIG. 1, the positive electrode 104a and the first plastic perforated plate 106a may be separated by a spacer 108, and the negative electrode 104b and the second plastic perforated plate 106b may similarly be separated by a spacer 108. As with distances a and b, the spacers 108 may be the same length or different lengths.

In accordance with certain embodiments, the positive electrode 104a, the negative electrode 104b, the first plastic perforated plate 106a, and/or the second plastic perforated plate 106b may have a length L. In some embodiments, for example, the length L may be from about 100 mm to about 1000 mm. In other embodiments, the length L may be from about 200 mm to about 800 mm. In further embodiments, the length L may be from about 300 mm to about 500 mm. In certain embodiments, for instance, the length L may be about 400 mm. In this regard, the length L may be at least about any of the following: 100, 200, 300, 400, 500, 600, 700, 800, and 900 mm and/or at most about 1000, 900, 800, 700, 600, 500, 400, 300, and 200 mm (e.g., about 300-600 mm, about 200-400 mm, etc.).

According to certain embodiments, the grooves 110 may be only slightly thicker than each of the positive electrode 104a, the negative electrode 104b, the first plastic perforated plate 106a, and the second plastic perforated plate 106b such that each of the positive electrode 104a, the negative electrode 104b, the first plastic perforated plate 106a, and the second plastic perforated plate 106b snugly fit within the grooves 110. As such, the thickness of each individual groove may be selected to be up to 1 mm thicker (e.g., 0.1 mm, 0.5 mm, 0.8 mm, etc.) than the distance a or b. By way of example only, in certain embodiments in which the distance a and/or b is 2 mm, then the respective grooves 110 may be 2.1 mm thick. Similarly, the grooves 110 may be only slightly longer than each of the positive electrode 104a, the negative electrode 104b, the first plastic perforated plate 106a, and the second plastic perforated plate 106b such that each of the positive electrode 104a, the negative electrode 104b, the first plastic perforated plate 106a, and the second plastic perforated plate 106b snugly fit within the grooves 110. As such, the length of each individual groove may be selected to be up to 1 mm longer (e.g., 0.1 mm, 0.5 mm, 0.8 mm, etc.) than the length L. By way of example only, in certain embodiments in which the length L is 400 mm, then the respective grooves 110 may be 400.1 mm long.

In accordance with certain embodiments, and as shown in FIG. 1, each of the positive electrode 104a, the negative electrode 104b, the first plastic perforated plate 106a, and/or the second plastic perforated plate 106b may have a height H. In some embodiments, for example, the height H may be from about 10 mm to about 400 mm. In other embodiments, the height H may be from about 50 mm to about 250 mm. In further embodiments, the height H may be from about 75 mm to about 150 mm. In certain embodiments, for instance, the height H may be about 100 mm. In this regard, the height H may be at least about any of the following: 10, 25, 50, 75, 100, 150, 200, 250, 300, and 350 mm and/or at most about 400, 350, 300, 250, 200, 150, 100, 75, 50, and 25 mm (e.g., about 50-150 mm, about 25-350 mm, etc.).

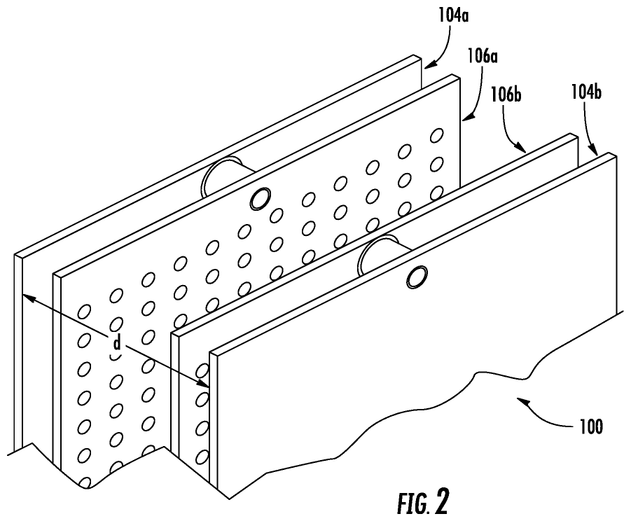

Moreover, as can be seen in FIG. 2, the positive electrode 104a and the negative electrode 104b are separated by a distance d. In some embodiments, for example, the distance d may be from about 10 mm to about 100 mm. In other embodiments, the distance d may be from about 25 mm to about 75 mm. In further embodiments, the distance d may be about 50 mm. In this regard, the distance d may be at least about any of the following: 10, 15, 20, 25, 30, 35, 40, 45, 50, 55, 65, 70, 75, 80, 85, 90, and 95 mm and/or at most about 100, 95, 90, 85, 80, 75, 70, 65, 60, 55, 50, 45, 40, 35, 30, 25, 20, and 15 mm (e.g., about 20-95 mm, about 35-80 mm, etc.).

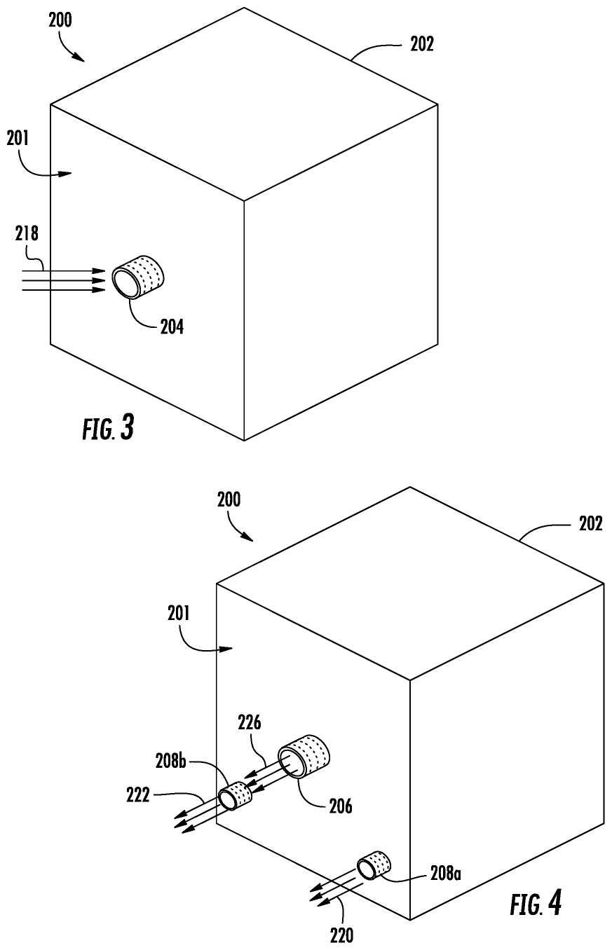

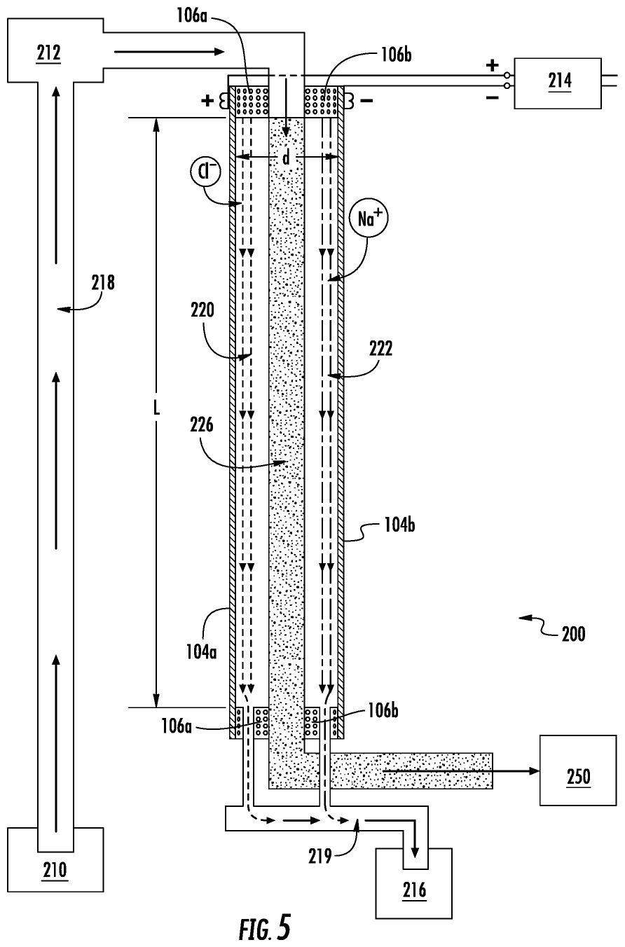

In accordance with certain embodiments, the saltwater to freshwater converter cell may be disposed within a housing. For example, as shown in FIGS. 3 and 4, the saltwater to freshwater converter 200 may be disposed within a housing 202. FIG. 3 illustrates the front of the housing 202. As can be seen in FIG. 3, the front of the housing 202 may include a saltwater entry port 204 through which the saltwater stream 218 may enter the saltwater to freshwater converter 200. FIG. 4 illustrates the back of the housing 202, which is positioned opposite the front of the housing 202. As can be seen in FIG. 4, the back of the housing 202 may include a desalinated water channel exit port 206 through which the desalinated water channel 226 may exit the housing 202. The back of the housing 202 may also include a chloride-dense water channel exit port 208a and a sodium-dense water channel exit port 208b through which the chloride-dense water channel 220 and the sodium-dense water channel 222, respectively, may exit the housing 202. Moreover, in some embodiments, the power supply 214 may be disposed within the housing 202. In other embodiments, however, the power supply 214 may be disposed outside the housing 202.

FIG. 5 is a schematic view of a one cell saltwater to freshwater converter 200 in accordance with certain embodiments of the invention. As shown in FIG. 5, the saltwater to freshwater converter 200 may include a saltwater (e.g., seawater) source 210 that provides the saltwater stream 218 to the converter 200. In some embodiments, the saltwater stream may comprise unprocessed saltwater 218. In other embodiments, however, the saltwater stream may comprise processed saltwater 219 or a combination of unprocessed saltwater 218 and processed saltwater 219.

According to certain embodiments, and as shown in FIG. 5, the converter 200 may include a pump 212 that pushes the unprocessed saltwater 218 through the converter 200 for processing. The pump 212 may be any suitable type and size of pump for pumping the saltwater 218 through the converter 200 as understood by a person of ordinary skill in the art. Indeed, the pump 212 must be capable of providing a water speed equal to the volume of the converter 200 divided by the amount of time required to move the distance d from one electrode to the other.

As shown in FIG. 5, the converter 200 also includes a power supply 214. According to certain embodiments, the power supply 214 may be a direct current (DC) power supply. In some embodiments, the DC power supply may produce a voltage between the electrodes from about 50 V to about 500 V. In other embodiments, the DC power supply may produce a voltage between the electrodes from about 100 V to about 300 V. In further embodiments, the DC power supply may produce a voltage between the electrodes of about 200 V. In this regard, the DC power supply may produce a voltage between the electrodes of at least about any the following: 50, 100, 150, 200, 250, 300, 350, 400, and 450 V and/or at most about 500, 450, 400, 350, 300, 250, 200, 150, and 100 V (e.g., about 100-400 V, about 200-300 V, etc.). While in many embodiments it is preferable to use a DC power supply, in some embodiments the power supply 214 may be an alternating current (AC) power supply.

As the saltwater 218 moves through the converter 200, the power supply 214 causes the positive sodium ions Na⁺ and the negative chloride ions Cl⁻ in the saltwater 218 to dissociate such that the Cl⁻ ions move towards the positive electrode 104a to form a chloride-dense water channel 220 between the positive electrode 104a and the first plastic perforated plate 106a and the Na⁺ ions move towards the negative electrode 104b to form a sodium-dense water channel 222 between the negative electrode 104b and the second plastic perforated plate 106b. In some embodiments, after traveling through length L of the converter 200, which is the main body of the converter 200, the chloride-dense water channel 220 and the sodium-dense water channel 222 may combine to form the processed saltwater 219. The processed saltwater 219 may then flow into a wastewater collection unit 216 for disposal or further processing, as described herein. As the Na⁺ ions and the Cl⁻ ions move towards the negative electrode 104b and the positive electrode 104a, respectively, the remaining water flowing through the converter 200 forms a desalinated water channel 226 between the first plastic perforated plate 106a and the second plastic perforated plate 106b. In some embodiments, this desalinated water channel 226 may then flow out of the converter 200 as processed freshwater, which may then be collected in a freshwater collection unit 250 or put through additional processing, as described herein.

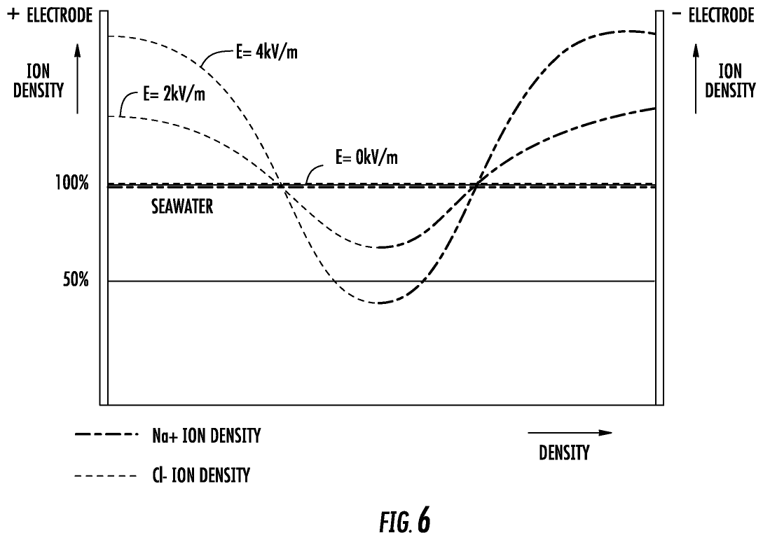

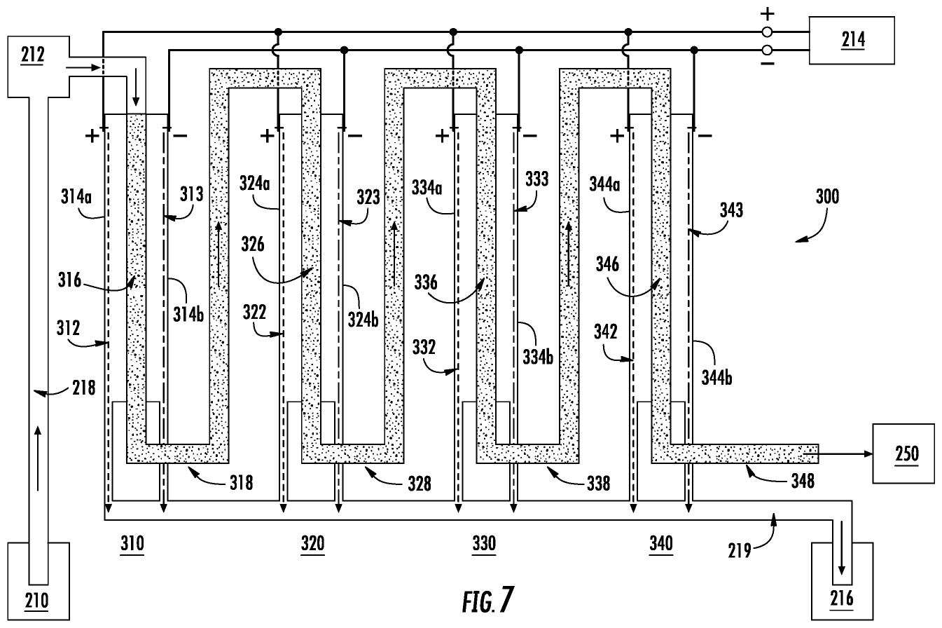

FIG. 6 illustrates the effect of various electric field strengths on ion density in a saltwater to freshwater converter in accordance with certain embodiments of the invention. As shown in FIG. 6, when no electric field (E=0 kV/m) is applied to the saltwater, the Na⁺ and Cl⁻ ion densities remain the same as seawater. When a moderate electric field strength (e.g., E=2 kV/m) is applied to the saltwater, the Cl⁻ ion density is highest at the positive electrode, the Na⁺ ion density is highest at the negative electrode, and the desalinated water has a reduction in both Na⁺ and Cl⁻ ion densities to greater than 50% but less than 100% of that of seawater (e.g., 60-75% of seawater). When a higher electric field strength (e.g., E=4 kV/m) is applied to the saltwater, the Cl⁻ ion density is highest at the positive electrode, the Na⁺ ion density is highest at the negative electrode, and the desalinated water has a reduction in both Na⁺ and Cl⁻ ion densities such that the ion densities are less than 50% of that of seawater (e.g., 30-40% of seawater). As such, and without intending to be limited by theory, as the electric field strength increases, so does the reduction in Na⁺ and Cl⁻ ion density in the desalinated water.

In this regard, the conversion cells are able to cleanly and efficiently convert saltwater to freshwater.

II. Saltwater to Freshwater Conversion Systems

In another aspect, certain embodiments according to the invention provide saltwater to freshwater conversion systems. The saltwater to freshwater conversion system includes at least a first saltwater to freshwater conversion cell and a second saltwater to freshwater conversion cell. Each of the saltwater to freshwater conversion cells includes a positive electrode; a negative electrode disposed opposite and parallel to the positive electrode; a first plastic perforated plate positioned adjacent to the positive electrode and between the positive electrode and the negative electrode; a second plastic perforated plate positioned adjacent to the negative electrode and between the positive electrode and the negative electrode; a power supply configured to generate an electric field between the positive electrode and the negative electrode; and a saltwater stream comprising a plurality of positively charged sodium ions and a plurality of negatively charged chloride ions, the saltwater stream flowing through the conversion cell. The positive electrode and the first plastic perforated plate define a chloride-dense water channel, the negative electrode and the second plastic perforated plate define a sodium-dense water channel, and the first plastic perforated plate and the second plastic perforated plate define a desalinated water channel. The electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel.

Turning now to FIG. 7, a saltwater to freshwater conversion system 300 is illustrated in accordance with certain embodiments of the invention. As shown in FIG. 7, the system 300 may include a plurality of saltwater to freshwater conversion cells. For example, in FIG. 7 the system 300 includes four conversion cells 310, 320, 330, and 340, but the system 300 is not so limited. In some embodiments, for instance, the system 300 may include three conversion cells, while in other embodiments, the system 300 may include five or more conversion cells.

Each conversion cell is largely the same as the converter 200 illustrated in FIG. 5, except the desalinated water channel may flow into another conversion cell for further processing rather than into a freshwater collection unit 250. For example, conversion cell 310 may include a positive electrode 314a, a negative electrode 314b, a chloride-dense water channel 312 running between the positive electrode 314a and the first plastic perforated plate (not shown), a sodium-dense water channel 313 running between the negative electrode 314b and the second plastic perforated plate (not shown), and a desalinated water channel 316 flowing between the first plastic perforated plate and the second plastic perforated plate. Desalinated water channel 316 may then flow through conversion cell 320. Conversion cell 320 may include a positive electrode 324a, a negative electrode 324b, a chloride-dense water channel 322 running between the positive electrode 324a and the first plastic perforated plate (not shown), a sodium-dense water channel 323 running between the negative electrode 324b and the second plastic perforated plate (not shown), and a desalinated water channel 326 flowing between the first plastic perforated plate and the second plastic perforated plate. Desalinated water channel 326 may then flow through conversion cell 330. Conversion cell 330 may include a positive electrode 334a, a negative electrode 334b, a chloride-dense water channel 332 running between the positive electrode 334a and the first plastic perforated plate (not shown), a sodium-dense water channel 333 running between the negative electrode 334b and the second plastic perforated plate (not shown), and a desalinated water channel 336 flowing between the first plastic perforated plate and the second plastic perforated plate. Desalinated water channel 336 may then flow through conversion cell 340. Conversion cell 340 may include a positive electrode 344a, a negative electrode 344b, a chloride-dense water channel 342 running between the positive electrode 344a and the first plastic perforated plate (not shown), a sodium-dense water channel 343 running between the negative electrode 344b and the second plastic perforated plate (not shown), and a desalinated water channel 346 flowing between the first plastic perforated plate and the second plastic perforated plate. Desalinated water channel 346 may then flow into the freshwater collection unit 250. Similarly, the processed saltwater 219 may then flow into the wastewater collection unit 216. While the system 300 is shown as having each desalinated water channel flow into the next conversion cell, any of the desalinated water channels may instead drain into a freshwater collection unit, such as freshwater collection unit 250.

As with the converter 200 shown in FIG. 5, the system 300 may include a seawater source 210, a pump 212, and a power supply 214. While the system 300 is shown as including one pump 212 and one power supply 214, the system 300 is not so limited. For example, the system 300 may include a plurality of pumps and power supplies, and in some embodiments, each conversion cell may be paired with its own pump and power supply.

As discussed above with respect to the converter 200, in some embodiments each saltwater to freshwater conversion cell may include a housing. In this regard, when multiple conversion cells are used, such as in the system 300, each conversion cell may be disposed in its own housing. In such embodiments, some or all of the housings may be connected to each other such that the desalinated water channel from a first conversion cell and housing will flow directly into a second conversion cell and housing. In other embodiments, however, the plurality of housings may not be directly connected to each other. In such embodiments, the desalinated water channel from a first conversion cell may be collected upon its exit from the housing and then transported to a second conversion cell and housing. In other embodiments, however, some or all of the conversion cells may be positioned within the same housing. For example, for system 300, all four conversion cells 310, 320, 330, 340 may be positioned within the same housing such that saltwater 218 enters the housing and the desalinated water channel 348 and processed saltwater 219 exit the housing.

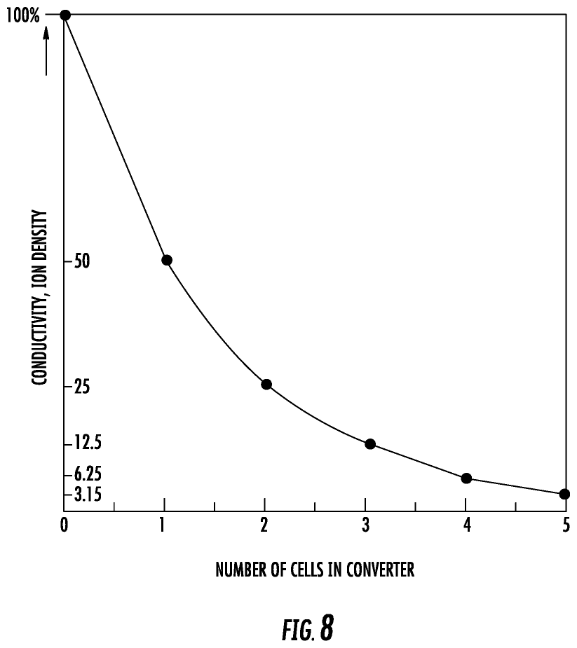

As discussed previously herein, the system 300 may include multiple (e.g., three, four, five, etc.) conversion cells. FIG. 8 illustrates the effect of the number of saltwater to freshwater conversion cells in a saltwater to freshwater conversion system on ion density (and, therefore, salt content) in the water being processed. As shown, in FIG. 8, as the number of conversion cells increases, the ion density of the water decreases, largely exponentially. Indeed, as shown in FIG. 8, by way of example only, unprocessed saltwater had an ion density of 100%, saltwater processed with one cell had an ion density of about 50%, saltwater processed with two cells had an ion density of about 25%, saltwater processed with three cells had an ion density of about 12.5%, saltwater processed with four cells had an ion density of about 6.25%, and saltwater processed with five cells had an ion density of about 3.15%.

In this regard, the system is able to cleanly and efficiently convert saltwater to freshwater.

III. Methods for Converting Saltwater to Freshwater

Certain embodiments according to the invention provide methods for converting saltwater to freshwater. The method includes providing a saltwater stream comprising a plurality of positively charged sodium ions and a plurality of negatively charged chloride ions; flowing the saltwater stream through a saltwater to freshwater conversion cell, the saltwater to freshwater conversion cell comprising a positive electrode, a negative electrode, a first plastic perforated plate, and a second plastic perforated plate, wherein the positive electrode and the first plastic perforated plate define a chloride-dense water channel, the negative electrode and the second plastic perforated plate define a sodium-dense water channel, and the first plastic perforated plate and the second plastic perforated plate define a desalinated water channel; generating an electric field across the saltwater stream; collecting wastewater from the sodium-dense water channel and the chloride-dense water channel; and collecting freshwater from the desalinated water channel. The electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel such that the plurality of positively charged sodium ions and the plurality of negatively charged chloride ions are substantially removed from water flowing through the desalinated water channel.

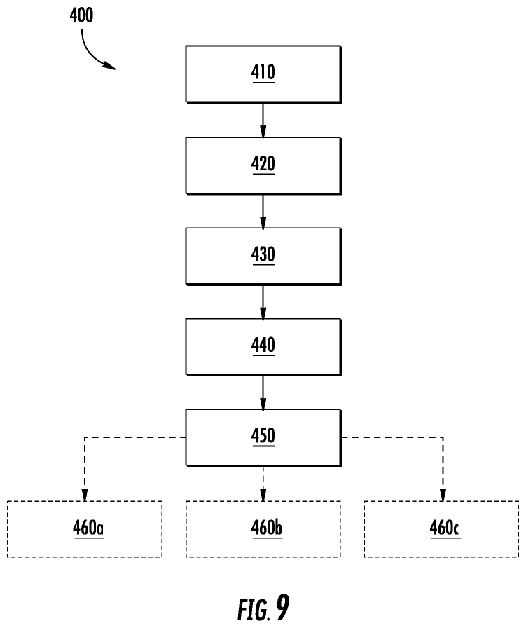

FIG. 9, for example, is a block diagram of a method 400 for converting saltwater to freshwater in accordance with certain embodiments of the invention. As shown in FIG. 9, the method 400 includes the following steps:

Step 410: Providing a saltwater stream comprising a plurality of positively charged sodium ions and a plurality of negatively charged chloride ions;

Step 420: Flowing the saltwater stream through a saltwater to freshwater conversion cell, the saltwater to freshwater conversion cell comprising a positive electrode, a negative electrode, a first plastic perforated plate, and a second plastic perforated plate, wherein the positive electrode and the first plastic perforated plate define a chloride-dense water channel, the negative electrode and the second plastic perforated plate define a sodium-dense water channel, and the first plastic perforated plate and the second plastic perforated plate define a desalinated water channel;

Step 430: Generating an electric field across the saltwater stream, wherein the electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel such that the plurality of positively charged sodium ions and the plurality of negatively charged chloride ions are substantially removed from water flowing through the desalinated water channel;

Step 440: Collecting wastewater from the sodium-dense water channel and the chloride-dense water channel; and

Step 450: Collecting freshwater from the desalinated water channel; and, optionally:

Step 460a: Disposing the wastewater; Step 460b: Recycling the wastewater through the saltwater to freshwater conversion cell; or

Step 460c: Flowing the freshwater through one or more additional saltwater to freshwater conversion cells.

In this regard, the method is able to cleanly and efficiently convert saltwater to freshwater.

### Example

A one-cell converter was constructed such that the distance d between the two electrodes was 0.05 m, the height H of the cell was 0.1 m, and the length L was 0.4 m, providing a 2 liter cell volume. The voltage between the electrodes was 200 V DC.

As such, based on Formulas 2 and 3 discussed above, the velocities of the ions were as follows:

v(Na)=6.75*10⁻⁸*m²*V⁻¹*s⁻¹*(200 V/0.05 m)=0.27 mm/s

v(Cl)=6.85*10⁻⁸*m²*V⁻¹*s⁻¹*(200 V/0.05 m)=0.30 mm/s

As such, an individual Na⁺ ion needs approximately 185 seconds to move the distance from one electrode to the other, and an individual ion needs approximately 167 seconds to move the distance from one electrode to the other. To ensure that all ions in the conversion cell would have enough time to reach their attracting electrodes, the pump was required to provide a water speed of 2 liters/185 seconds=0.011 l/s=40 l/h.

The following exemplary embodiments are provided, the numbering of which is not to be construed as designating levels of importance or relevance.

Embodiment 1 provides a saltwater to freshwater conversion cell comprising a positive electrode, a negative electrode disposed opposite and parallel to the positive electrode a first plastic perforated plate positioned adjacent to the positive electrode and between the positive electrode and the negative electrode, a second plastic perforated plate positioned adjacent to the negative electrode and between the positive electrode and the negative electrode, a power supply configured to generate an electric field between the positive electrode and the negative electrode, and a saltwater stream comprising a plurality of positively charged sodium ions and a plurality of negatively charged chloride ions, the saltwater stream flowing through the conversion cell, wherein the positive electrode and the first plastic perforated plate define a chloride-dense water channel, the negative electrode and the second plastic perforated plate define a sodium-dense water channel, and the first plastic perforated plate and the second plastic perforated plate define a desalinated water channel, and wherein the electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel.

Embodiment 2 provides the saltwater to freshwater conversion cell according to Embodiment 1, further comprising a housing having a saltwater entry port, a sodium-dense water channel exit port, a chloride-dense water channel exit port, and a desalinated water channel exit port, wherein the positive electrode, the negative electrode, the first plastic perforated plate, and the second plastic perforated plate are disposed within the housing.

Embodiment 3 provides the saltwater to freshwater conversion cell according to any one of Embodiments 1-2, wherein the saltwater stream enters the housing via the saltwater entry port, the sodium-dense water channel exits the housing via the sodium-dense water channel exit port, the chloride-dense water channel exits the housing via the chloride-dense water channel exit port, and the desalinated water channel exits the housing via the desalinated water channel exit port.

Embodiment 4 provides the saltwater to freshwater conversion cell according to any one of Embodiments 1-3, wherein the power supply is disposed within the housing.

Embodiment 5 provides the saltwater to freshwater conversion cell according to any one of Embodiments 1-4, wherein the power supply is a direct current (DC) power supply.

Embodiment 6 provides the saltwater to freshwater conversion cell according to any one of Embodiments 1-5, wherein the power supply is an alternating current (AC) power supply.

Embodiment 7 provides the saltwater to freshwater conversion cell according to any one of Embodiments 1-6, wherein the positive electrode and the negative electrode comprise stainless steel.

Embodiment 8 provides the saltwater to freshwater conversion cell according to any one of Embodiments 1-7, wherein the positive electrode and the negative electrode comprise surfaces having an electrical insulating plastic coating.

Embodiment 9 provides a saltwater to freshwater conversion system comprising at least a first saltwater to freshwater conversion cell and a second saltwater to freshwater conversion cell, each of the saltwater to freshwater conversion cells comprising a positive electrode, a negative electrode disposed opposite and parallel to the positive electrode, a first plastic perforated plate positioned adjacent to the positive electrode and between the positive electrode and the negative electrode, a second plastic perforated plate positioned adjacent to the negative electrode and between the positive electrode and the negative electrode, a power supply configured to generate an electric field between the positive electrode and the negative electrode, and a saltwater stream comprising a plurality of positively charged sodium ions and a plurality of negatively charged chloride ions, the saltwater stream flowing through the conversion cell, wherein the positive electrode and the first plastic perforated plate define a chloride-dense water channel, the negative electrode and the second plastic perforated plate define a sodium-dense water channel, and the first plastic perforated plate and the second plastic perforated plate define a desalinated water channel, and wherein the electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel.

Embodiment 10 provides the system according to Embodiment 9, wherein the system comprises three saltwater to freshwater conversion cells.

Embodiment 11 provides the system according to any one of Embodiments 9-10, wherein the system comprises four saltwater to freshwater conversion cells.

Embodiment 12 provides the system according to any one of Embodiments 9-11, wherein the system comprises five saltwater to freshwater conversion cells.

Embodiment 13 provides the system according to any one of Embodiments 9-12, wherein each saltwater to freshwater conversion cell further comprises a housing having a saltwater entry port, a sodium-dense water channel exit port, a chloride-dense water channel exit port, and a desalinated water channel exit port, wherein the positive electrode, the negative electrode, the first plastic perforated plate, and the second plastic perforated plate are disposed within the housing.

Embodiment 14 provides the system according to any one of Embodiments 9-13, wherein the sodium-dense water channel exits the housing via the sodium-dense water channel exit port, the chloride-dense water channel exits the housing via the chloride-dense water channel exit port, and the desalinated water channel exits the housing via the desalinated water channel exit port.

Embodiment 15 provides the system according to any one of Embodiments 9-14, wherein the sodium-dense water channel exit port and the chloride-dense water channel exit port of each of the saltwater to freshwater conversion cells drain into a wastewater collection unit, the desalinated water channel exit port of the first saltwater to freshwater conversion cell drains into the saltwater entry port of the second saltwater to freshwater conversion cell, and the desalinated water channel exit port of the second saltwater to freshwater conversion cell drains either into a freshwater collection unit or a saltwater entry port of a third saltwater to freshwater conversion cell.

Embodiment 16 provides the system according to any one of Embodiments 9-15, wherein at least the first saltwater to freshwater conversion cell and the second saltwater to freshwater conversion cell are disposed in a housing, the housing having a saltwater entry port, a sodium-dense water channel exit port, a chloride-dense water channel exit port, and a desalinated water channel exit port.

Embodiment 17 provides the system according to any one of Embodiments 9-16, wherein the power supply is a direct current (DC) power supply.

Embodiment 18 provides a method for converting saltwater to freshwater, the method comprising providing a saltwater stream comprising a plurality of positively charged sodium ions and a plurality of negatively charged chloride ions, flowing the saltwater stream through a saltwater to freshwater conversion cell, the saltwater to freshwater conversion cell comprising a positive electrode, a negative electrode, a first plastic perforated plate, and a second plastic perforated plate, wherein the positive electrode and the first plastic perforated plate define a chloride-dense water channel, the negative electrode and the second plastic perforated plate define a sodium-dense water channel, and the first plastic perforated plate and the second plastic perforated plate define a desalinated water channel, generating an electric field across the saltwater stream, wherein the electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel such that the plurality of positively charged sodium ions and the plurality of negatively charged chloride ions are substantially removed from water flowing through the desalinated water channel, collecting wastewater from the sodium-dense water channel and the chloride-dense water channel, and collecting freshwater from the desalinated water channel.

Embodiment 19 provides the method according to Embodiment 18, further comprising disposing the wastewater or recycling the wastewater through the saltwater to freshwater conversion cell.

Embodiment 20 provides the method according to any one of Embodiments 18-19, further comprising flowing the freshwater through one or more additional saltwater to freshwater conversion cells.

Modifications of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A saltwater to freshwater conversion cell comprising:
a positive electrode;
a negative electrode disposed opposite and parallel to the positive electrode;
a first plastic perforated plate positioned adjacent to the positive electrode and between the positive electrode and the negative electrode;
a second plastic perforated plate positioned adjacent to the negative electrode and between the positive electrode and the negative electrode;
a power supply configured to generate an electric field between the positive electrode and the negative electrode; and
a saltwater stream comprising a plurality of positively charged sodium ions and a plurality of negatively charged chloride ions, the saltwater stream flowing through the conversion cell,
wherein the positive electrode and the first plastic perforated plate define a chloride-dense water channel, the negative electrode and the second plastic perforated plate define a sodium-dense water channel, and the first plastic perforated plate and the second plastic perforated plate define a desalinated water channel, and
wherein the electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel.

2. The saltwater to freshwater conversion cell according to claim 1, further comprising a housing having a saltwater entry port, a sodium-dense water channel exit port, a chloride-dense water channel exit port, and a desalinated water channel exit port, wherein the positive electrode, the negative electrode, the first plastic perforated plate, and the second plastic perforated plate are disposed within the housing.

3. The saltwater to freshwater conversion cell according to claim 2, wherein the saltwater stream enters the housing via the saltwater entry port, the sodium-dense water channel exits the housing via the sodium-dense water channel exit port, the chloride-dense water channel exits the housing via the chloride-dense water channel exit port, and the desalinated water channel exits the housing via the desalinated water channel exit port.

4. The saltwater to freshwater conversion cell according to claim 1, wherein the power supply is disposed within the housing.

5. The saltwater to freshwater conversion cell according to claim 1, wherein the power supply is a direct current (DC) power supply.

6. The saltwater to freshwater conversion cell according to claim 1, wherein the power supply is an alternating current (AC) power supply.

7. The saltwater to freshwater conversion cell according to claim 1, wherein the positive electrode and the negative electrode comprise stainless steel.

8. The saltwater to freshwater conversion cell according to claim 1, wherein the positive electrode and the negative electrode comprise surfaces having an electrical insulating plastic coating.

9. A saltwater to freshwater conversion system comprising:
at least a first saltwater to freshwater conversion cell and a second saltwater to freshwater conversion cell, each of the saltwater to freshwater conversion cells comprising:
a positive electrode;
a negative electrode disposed opposite and parallel to the positive electrode;
a first plastic perforated plate positioned adjacent to the positive electrode and between the positive electrode and the negative electrode;
a second plastic perforated plate positioned adjacent to the negative electrode and between the positive electrode and the negative electrode;
a power supply configured to generate an electric field between the positive electrode and the negative electrode; and
a saltwater stream comprising a plurality of positively charged sodium ions and a plurality of negatively charged chloride ions, the saltwater stream flowing through the conversion cell,
wherein the positive electrode and the first plastic perforated plate define a chloride-dense water channel, the negative electrode and the second plastic perforated plate define a sodium-dense water channel, and the first plastic perforated plate and the second plastic perforated plate define a desalinated water channel, and
wherein the electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel.

10. The system according to claim 9, wherein the system comprises three saltwater to freshwater conversion cells.

11. The system according to claim 9, wherein the system comprises four saltwater to freshwater conversion cells.

12. The system according to claim 9, wherein the system comprises five saltwater to freshwater conversion cells.

13. The system according to claim 9, wherein each saltwater to freshwater conversion cell further comprises a housing having a saltwater entry port, a sodium-dense water channel exit port, a chloride-dense water channel exit port, and a desalinated water channel exit port, wherein the positive electrode, the negative electrode, the first plastic perforated plate, and the second plastic perforated plate are disposed within the housing.

14. The system according to claim 13, wherein the sodium-dense water channel exits the housing via the sodium-dense water channel exit port, the chloride-dense water channel exits the housing via the chloride-dense water channel exit port, and the desalinated water channel exits the housing via the desalinated water channel exit port.

15. The system according to claim 13, wherein the sodium-dense water channel exit port and the chloride-dense water channel exit port of each of the saltwater to freshwater conversion cells drain into a wastewater collection unit, the desalinated water channel exit port of the first saltwater to freshwater conversion cell drains into the saltwater entry port of the second saltwater to freshwater conversion cell, and the desalinated water channel exit port of the second saltwater to freshwater conversion cell drains either into a freshwater collection unit or a saltwater entry port of a third saltwater to freshwater conversion cell.

16. The system according to claim 9, wherein at least the first saltwater to freshwater conversion cell and the second saltwater to freshwater conversion cell are disposed in a housing, the housing having a saltwater entry port, a sodium-dense water channel exit port, a chloride-dense water channel exit port, and a desalinated water channel exit port.

17. The system according to claim 9, wherein the power supply is a direct current (DC) power supply.

18. A method for converting saltwater to freshwater, the method comprising:
providing a saltwater stream comprising a plurality of positively charged sodium ions and a plurality of negatively charged chloride ions;
flowing the saltwater stream through a saltwater to freshwater conversion cell, the saltwater to freshwater conversion cell comprising a positive electrode, a negative electrode, a first plastic perforated plate, and a second plastic perforated plate, wherein the positive electrode and the first plastic perforated plate define a chloride-dense water channel, the negative electrode and the second plastic perforated plate define a sodium-dense water channel, and the first plastic perforated plate and the second plastic perforated plate define a desalinated water channel;
generating an electric field across the saltwater stream, wherein the electric field is configured to cause the plurality of negatively charged chloride ions in the saltwater stream to move through the first plastic perforated plate and into the chloride-dense water channel and the plurality of positively charged sodium ions in the saltwater stream to move through the second plastic perforated plate and into the sodium-dense water channel such that the plurality of positively charged sodium ions and the plurality of negatively charged chloride ions are substantially removed from water flowing through the desalinated water channel;
collecting wastewater from the sodium-dense water channel and the chloride-dense water channel; and
collecting freshwater from the desalinated water channel.

19. The method according to claim 18, further comprising disposing the wastewater or recycling the wastewater through the saltwater to freshwater conversion cell.

20. The method according to claim 18, further comprising flowing the freshwater through one or more additional saltwater to freshwater conversion cells.
